(19) United States
(12) Patent Application Publication
(10) Pub. No.: US 2013/0038098 A1
(43) Pub. Date: Feb. 14, 2013

(54) ADAPTER APPARATUS, VEHICLE SEAT, MOTOR VEHICLE, AND METHOD FOR THE ABSORPTION OF KINETIC ENERGY OF A VEHICLE SEAT

(71) Applicant: Juergen MAIER, Weitersweiler (DE)

(72) Inventor: Juergen MAIER, Weitersweiler (DE)

(73) Assignee: GM GLOBAL TECHNOLOGY OPERATIONS LLC, Detroit, MI (US)

(21) Appl. No.: 13/549,663

(22) Filed: Jul. 16, 2012

(30) Foreign Application Priority Data
Jul. 16, 2011 (DE) 10 2011 107 596.1

(51) Int. Cl. B60N 2/427; B60N 2/42

(52) U.S. Cl. 297/216.1

(57) ABSTRACT

A seat adapter apparatus for fixing a seat frame to a moving part of a seat rail of a vehicle seat of a motor vehicle is provided. The seat adapter apparatus has a seat frame side with a seat mount and an energy absorption device coupled to the seat frame side. The energy absorption device is configured to absorb at least a portion of the kinetic energy of the vehicle seat and/or redirect it to the seat rail in the event of a crash of the motor vehicle.

### CROSS-REFERENCE TO RELATED APPLICATION

This application claims priority to German Patent Application No. 10 2011 107 596.1, filed Jul. 16, 2011, which is incorporated herein by reference in its entirety.

### TECHNICAL FIELD

The technical field relates to an adapter apparatus having at least one seat frame side with a seat mount, a vehicle seat of a motor vehicle, a motor vehicle, and a method for the absorption of kinetic energy of a vehicle seat.

### BACKGROUND

Energy absorption apparatuses for vehicle seats in motor vehicles are generally known. In these conventional energy absorption apparatuses, a backrest of the vehicle seat is primarily prevented from being moved forward in the direction of the seat surface portion as a result of the high acceleration forces in the event of a rear crash. To this end, various energy absorption elements are introduced between the backrest and the seat surface portion depending on the design, which absorb the kinetic energy of the backrest in the event of a rear crash.

In another known design of the energy absorption apparatus, this is mounted between the seat frame and the seat rails of a vehicle seat. By this means the vehicle seat is supported at the bottom toward the front in the event of a crash.

DE 10 2004 020 931 A1 discloses a vehicle seat, in particular a motor vehicle seat, comprising a seat frame carrying a seat cushion and a longitudinal adjuster comprising at least one first seat rail, at least one second seat rail guided movably in the longitudinal direction in the first seat rail, and at least one adapter for at least indirect connection of the seat frame on one side to the adapter. The adapter is mounted on the second seat rail and is normally located at a distance from the first seat rail. The adapter comprises a support, which comes in contact with the first seat rail in the event of a crash. The adapter thereby extends approximately over the entire length of the seat rail. By means of the rail-side support, the vehicle seat is supported at the bottom toward the front in the event of a frontal crash and the kinetic energy of the vehicle seat is guided to the seat rails and absorbed there. No support or energy absorption is provided in this case in the event of a rear crash.

It is therefore at least one object herein to provide an improved energy absorption apparatus and a method for energy absorption for a seat rail of a vehicle seat, which absorbs kinetic energy of the vehicle seat primarily in the event of a rear crash. In particular, it is at least one object herein to provide a vehicle seat and a motor vehicle for this purpose. In addition, other objects, desirable features and characteristics will become apparent from the subsequent summary and detailed description, and the appended claims, taken in conjunction with the accompanying drawings and this background.

### SUMMARY

According to an embodiment, an adapter apparatus, in particular a seat adapter, for fixing a seat frame to a moving part of a seat rail of a vehicle seat of a motor vehicle, comprises a seat frame side with a seat mount. One or more energy absorption devices are formed on the seat frame side in order to absorb at least a portion of the kinetic energy of the vehicle seat and/or redirect it to the seat rail in the event of a crash of the motor vehicle.

Such an adapter apparatus having an energy absorption device in the event of a crash absorbs at least a portion of the kinetic energy of the vehicle seat by means of the energy absorption device. For example at least 50% of the kinetic energy, for example at least 75%, such as at least 90% is absorbed. The crash in particular comprises a rear crash, that is for example, a rear-end collision, where a rear crash also covers an angle of impact which differs from a longitudinal axis of the motor vehicle. The energy absorption device thereby functions as a crumple zone in one embodiment.

In one embodiment, the adapter apparatus comprises one or more seat frame sides with the seat mount and one or more opposite seat rail sides, by which means the adapter apparatus is disposed on the moving part of the seat rail. Preferably precisely one seat frame side and one seat rail side are formed in each case. The seat frame side is advantageously concavely shaped so that the seat frame can be received at least partially, but on both sides, in the concave shape of the seat mount. In other embodiments the seat frame side is U-shaped or C-shaped, that is, with a side wall on both sides as a boundary. The seat rail side is preferably designed to be flat so that the adapter apparatus rests with this side flat on the moving rail part. Another design, for example, with a side wall, is also possible. The adapter apparatus is firmly connected to the seat frame and the seat rail, for example, screwed, riveted, and/or welded. For example, fixing elements in the form of screw holes are provided in the side wall of the seat mount for a screw connection. The seat rail comprises the moving part and a stationary part fixed on the motor vehicle, in particular on an underfloor, where the two parts are movable with respect to one another, in particular displaceable. In an embodiment, the adapter apparatus and/or the energy absorption device is disposed in a rear area, that is, at the rear side or in an area below a seat rest of the vehicle seat, on the movable seat rail.

Furthermore, in one embodiment the adapter apparatus has on the seat frame side fixing elements or receptacles for fixing or receiving further components of the vehicle seat, for example, a safety belt system. The fixing elements are designed, for examples as molded tabs with openings for pushing through complementary fixing parts.

The energy absorption device, absorption device for short, is preferably formed on the seat frame side, in the area of the seat mount. In one embodiment precisely one absorption device is provided, in other embodiments more than one, for example two or three, absorption devices are provided. The absorption device projects into the seat mount from a base surface or the seat frame side, that is, the absorption device projects from the seat frame side in the direction of the seat frame so that the absorption device is spaced apart from the seat rail side and the seat rail and does not directly contact the seat rail. Support of the absorption device on the seat rail is therefore not possible. In one embodiment, the absorption device is configured to be rigid, that is not deformable, and thus functions as a force redirector in order to direct a force produced in the event of a crash into the adapter apparatus.

In one embodiment, the energy absorption device is configured to be deformable in order to absorb the kinetic energy of the vehicle seat at least partially by deformation in the event of a crash. The kinetic energy is thereby converted into deformation energy and heat. In this case, the absorption device acts as a crumple zone. The deformation of the absorption device is in this case accomplished irreversibly, reversibly, and/or elastically. The advantage of a reversible or elastic deformation is that the kinetic energy in the event of a crash can be multiply absorbed, for example in the event of two or three crashes such as can occur as a result of linked rear-end collisions. In an embodiment, predetermined breaking points are not provided.

In other embodiments it is provided that the absorption device is formed integrally in the adapter apparatus. In this embodiment, the absorption device and the adapter apparatus are designed in one piece. This in particular avoids predetermined breaking points in the area of the connection points, which possibly yield already under a low loading. The adapter apparatus is preferably formed with the absorption device as a cast part.

In yet another embodiment, the absorption device is formed separately from the adapter apparatus and is connected to the apparatus. In this embodiment the absorption device and the adapter apparatus are designed as multipart, for example, two- or three-part. For example, the absorption device and the adapter apparatus are welded, riveted, and/or screwed together. In this regard, the absorption device can be retrofitted and/or exchanged. An absorption device which has been irreversibly deformed after a crash, which can no longer absorb any energy, can be exchanged and replaced by a new, fully functional absorption device.

In a further embodiment, the absorption device is formed in one part. In this regard, predetermined breaking points inside the absorption device are avoided. The absorption device is formed, for example as a sheet metal part or the like. In this case, the sheet metal has various shapes, angles, lengths, widths, material thicknesses, moldings, recesses etc. For example, the absorption device projects with a different length or height in the direction of the seat frame. The absorption device is preferably disposed on a rear end of the adapter apparatus. The absorption device, in an embodiment, is disposed on a transverse side. In another embodiment the absorption device is formed as an angle, which is disposed along a corner region of the adapter apparatus.

Alternatively it is provided in yet another embodiment that the absorption device is formed in multiple parts with connected segments. For example, the absorption device is configured to be two- or three-part, that is with two or three individual segments, where the individual segments are interconnected, for example welded, riveted and/or screwed. The individual segments are, for example connected to one another at right angles or obliquely, that is in an angular arrangement. Depending on the design and arrangement of the segments, a multipart embodiment of the absorption device advantageously has a higher stiffness than a one-part design. In one embodiment, the plurality of segments is arranged in a row, that is, at least partly adjacent to one another. In another embodiment the arrangement of at least two segments is parallel, that is at least partially overlapping. As a result, the stiffness of the absorption device is variable.

The absorption device can be designed with different shapes, where the type of the shape and also the thickness influence the stiffness of the absorption device. For example, the absorption device can be designed to be rectangular, V-shaped, flat, bridge-shaped, angular etc. In a further embodiment, the absorption device projects at an angle of less than or equal to 90o from the seat frame side. Regardless of the precise design of the absorption device, this projects in each case by a certain height from the seat frame side of the adapter apparatus. The greater the height, the higher the energy that can be absorbed. A precise description of the different shapes of the absorption device is provided within the framework of the description of the figures.

Furthermore, the stiffness of the absorption device is determined by the choice of material. The material is preferably selected so that it is capable of absorbing energy by deformation. For this reason, one embodiment provides that the absorption device is formed from a metal, in particular aluminum and/or carbon. In one embodiment, in particular in a one-part embodiment of absorption device and adapter apparatus, these components are made of the same material. In other embodiments, in particular in multipart embodiments of absorption device and adapter apparatus, these components are made of different materials.

In a vehicle seat of a motor vehicle, at least comprising a seat rail and a seat frame, which is fixed on an at least partially movable portion of the seat rail with a seat adapter, the seat adapter is configured as the previously described adapter apparatus. In an embodiment, the vehicle seat is connected on both sides to respectively one adapter apparatus with a seat rail. The vehicle seat, for example, is mounted in a fixed position on the moving part of the seat rail. The fixed part of the seat rail is fixed in a fixed position on the underfloor of the motor vehicle. The moving part of the seat rail is displaceable with respect to the stationary or immovable part of the seat rail. The vehicle seat comprises a seat frame, two seat rails each with a moving and fixed part, a seat rest, and a seat cushion, that is mounted on the seat frame as a seat surface. In another embodiment the seat comprises a seat shell.

In another embodiment, the absorption device is formed depending on a block size of the vehicle seat, where the height of the absorption device increases with the block size. The block size is understood as a distance from a theoretical, vehicle-specific seating point, also called H point, in a lowest position of a height adjustment of the vehicle seat as far as a lower edge of the moving part of the seat rail. In this case, the seating point is a point on a lower side of a seating surface of the vehicle seat when there is a specific, standardized weight on the seating surface, for example, a test dummy The block size is a vehicle- and seat-specific size and is interpreted accordingly. In one embodiment, the block size measures about 185 mm±15 mm. By adjusting the block size, the vehicle seat can be individually adapted to the particular motor vehicle. The absorption device is also adapted by adjusting the block size. An adaptation of the absorption device, for example, involves changing the geometry, in particular the height and/or the thickness. With a larger block size, the height of the absorption device is correspondingly greater. Conversely, with a smaller block size the height of the absorption device is smaller.

In a motor vehicle at least comprising a seating device, the seating device is configured as the vehicle seat described previously. The motor vehicle is for example configured as an estate car, limousine, SUV, all-terrain vehicle, or the like. In the event of a rear crash, the vehicle seat is accelerated downward toward the back as a result of its inertia, that is, its seat rest tilts backward. In so doing the seat frame is pressed onto the seat rail and damages the seat rail in conventional vehicle seats. However, the absorption device between seat frame and seat rail absorbs the kinetic energy and prevents contact of seat frame and seat rail or damage or destruction of the seat rail. The kinetic energy is at least for the most part absorbed by the deformation of the absorption device. If the kinetic energy is not completely absorbed, the kinetic energy is redirected onto the seat rail and the rest of the motor vehicle due to contact of the adapter apparatus with the seat rail. A force path is thus formed.

The absorption device is suitable for installation in the vehicle seats of a front row of seats, that is, driver seat and/or passenger seat, since in the event of the seat rests or the vehicle seats tilting toward the back, these would otherwise be pressed against the knee of passengers on the rear row of seats and could injure them. The adapter apparatus is also suitable for rear rows of seats. The rows of seats also comprise individual vehicle seats such as driver's seats, passenger seats, foldaway seats, or other single seats. The absorption device significantly reduces the risk of injury for vehicle occupants.

In a method for absorption of kinetic energy of a vehicle seat in the event of a crash, in particular a vehicle seat described previously in the event of a rear crash, the kinetic energy is absorbed at least partially by one or more adapter apparatus and/or is redirected to the seat rail. In a rear crash, crash energy is transferred inter alia to the motor vehicle seat. This is accelerated accordingly so that the seat rest is accelerated for example in the direction of the vehicle rear. The force acting in this case is transferred via the adapter apparatus. Due to the absorption device provided, this force is converted at least for the most part into deformation energy and heat due to deformation of the absorption device, with the result that the force is reduced.

In one embodiment, the kinetic energy is dissipated in multiple stages, in particular in two stages, whereby firstly kinetic energy is dissipated by deformation or distortion of the energy absorption device and a remaining fraction of the kinetic energy is redirected to the seat rail via the adapter apparatus. In this case, in a first absorption step the kinetic energy is absorbed by means of deformation and only in a second, optional absorption step is the rest of the not yet absorbed kinetic energy redirected to the seat rails. For example, at least 50%, for example at least 75%, such as at least 90%, of the kinetic energy is absorbed in the first absorption step. The distribution of the energy absorption between the two absorption steps is particularly dependent on the design, among other things, on the stiffness and deformability of the absorption device. A higher stiffness is achieved for example by the choice of material, the thickness, and the shaping of the absorption device.

### BRIEF DESCRIPTION OF THE DRAWINGS

The various embodiments will hereinafter be described in conjunction with the following drawing figures, wherein like numerals denote like elements, and wherein:

FIG. 1 shows a perspective view of a supporting structure of a vehicle seat with two adapter apparatuses;

FIG. 2 shows a perspective view of the adapter apparatus with a first embodiment of an absorption device;

FIG. 3 shows a section of a perspective side view of the supporting structure of the vehicle seat according to FIG. 1; and

FIGS. 4a-d show various embodiments of the absorption device in perspective views.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

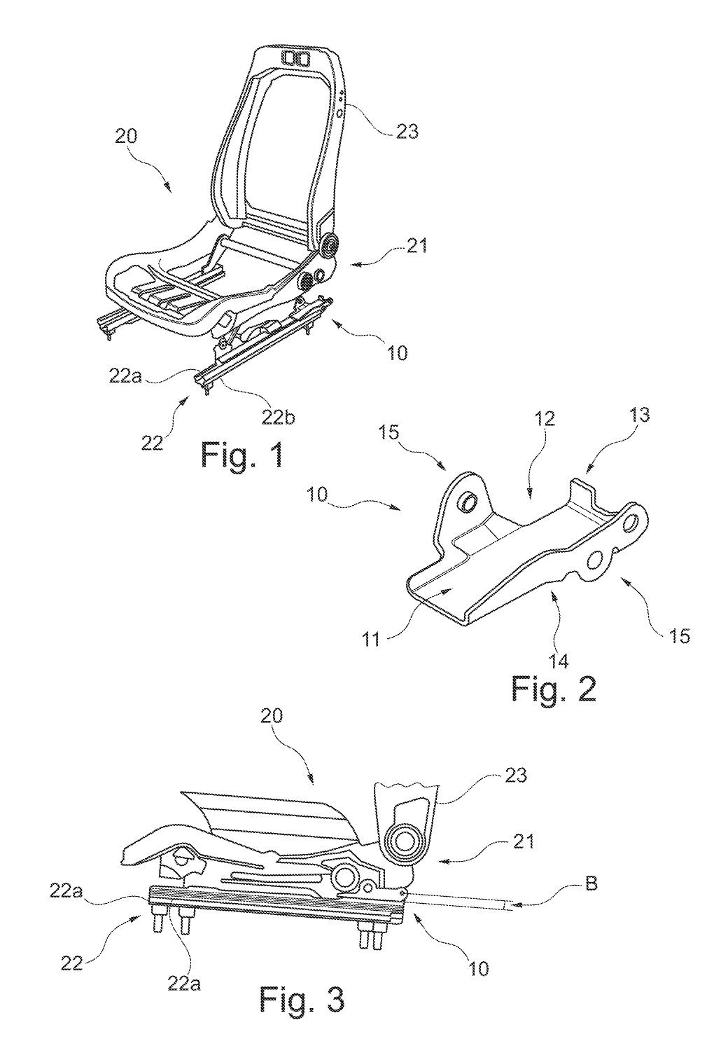

FIG. 1 shows a perspective view of a supporting structure of a vehicle seat 20 with two adapter apparatuses 10, where only the adapter apparatus 10 disposed on the side of the vehicle seat 20 facing the observer can be seen. The vehicle seat 20 or the supporting structure comprises a seat frame 21, on both sides of which are respectively one seat rail 22 and one seat rest frame 23. The seat rail 22 comprises a movable part 22a and a fixed part 22b, where both parts are displaceable with respect to one another. In each case, the adapter apparatus 10 is fixed in a fixed position on the moving part 22a. In the embodiment of FIG. 1, the adapter apparatus 10 is disposed in the rear area of the seat rail 22, that is, in the area near the seat rest frame 23. The fixed part 22b of the seat rail 22 is fixed in a fixed position on an underfloor of a motor vehicle (both not shown for clarity). The adapter apparatus 10 is further connected to the seat frame 21 and thus connects the seat frame 21 to the seat rail 22. In the embodiment of FIG. 1, the adapter apparatus 10 is welded to the seat frame 21 and the seat rail 22.

FIG. 2 shows a perspective view of an adapter apparatus 10 with a first embodiment of the absorption device 13. The adapter apparatus 10 is configured as a seat adapter for fixing the seat frame 21 on the moving part 22a of the seat rail 22 of the vehicle seat 20 of the motor vehicle. According to the embodiment of FIG. 2, the adapter apparatus 10 has a seat frame side 11 and an opposite seat rail side 14. The seat frame side 11 is configured to be concave and thus forms a clip-type seat mount 12 for receiving the seat frame 21 of the vehicle seat 20. Fixing elements 15 in the form of molded tabs with openings, here with holes, are additionally formed on the seat frame side 11 in order for example to fasten a safety belt of the vehicle seat 20 (not shown). The seat rail side 14 is configured to be planar and flat so that this rests on the moving part of the seat rail 22a. The adapter apparatus 10 is fixed, for example welded, with the seat rail side 14 on the moving seat rail 22a of the vehicle seat 20.

On the seat frame side 11, the adapter apparatus 10 has an energy absorption device 13, absorption device 13 for short, in order to absorb and/or redirect to the seat rail 22 the largest possible part of the kinetic energy of the vehicle seat 20 in the event of a rear crash of the motor vehicle. According to FIG. 2, the absorption device 13 is configured as a molded tongue, for example as sheet metal, where the tongue projects from the seat frame side 11 in the direction of the seat frame 21 (not shown). The tongue-shaped absorption device 13 is designed in one piece with the adapter apparatus 10, that is, integrated therein. The absorption device 13 is here located on a rear region of the adapter apparatus 10, here on an end region. In the embodiment of FIG. 2 the absorption device 13 and therefore the entire adapter apparatus 10 is formed from a metal such as aluminum or carbon. The energy absorption device 13, absorption device 13 for short, is configured to be deformable according to FIG. 2 in order to absorb the kinetic energy by deformation. In the embodiment of FIG. 2, the deformation of the absorption device 13 is accomplished irreversibly. In the event of a rear crash, the kinetic energy of the vehicle seat 20 is accordingly converted into deformability or deformation work of the absorption device 13 and into heat. A precise description of the absorption of the kinetic energy is made in the description of FIG. 3.

FIG. 3 shows a section of a perspective side view of the supporting structure of the vehicle seat 20 according to FIG. 1. The vehicle seat 20 with its components and the adapter apparatus 10 correspond to those of the embodiment of FIGS. 1 and 2. A detailed description of components already described is thus dispensed with. In the event of a rear crash, that is for example in the event of a rear-end collision, the vehicle seat 20 tilts backward and downward with its backrest 23 as a result of its inertia. The seat frame 21 is thereby pressed onto the absorption device 13 of the adapter apparatus 10. The absorption device 13 is thereby deformed, where the kinetic energy of the vehicle seat 20 is absorbed by deformation and additionally converted into heat. If the entire kinetic energy is not absorbed by the deformation of the absorption device 13, the rest of the kinetic energy is passed on to the seat rail 22 and via this into the supporting structure of the motor vehicle. The deformation takes place irreversibly so that kinetic energy can only be absorbed once with this adapter apparatus 10. After that, the adapter apparatus 10 should be exchanged.

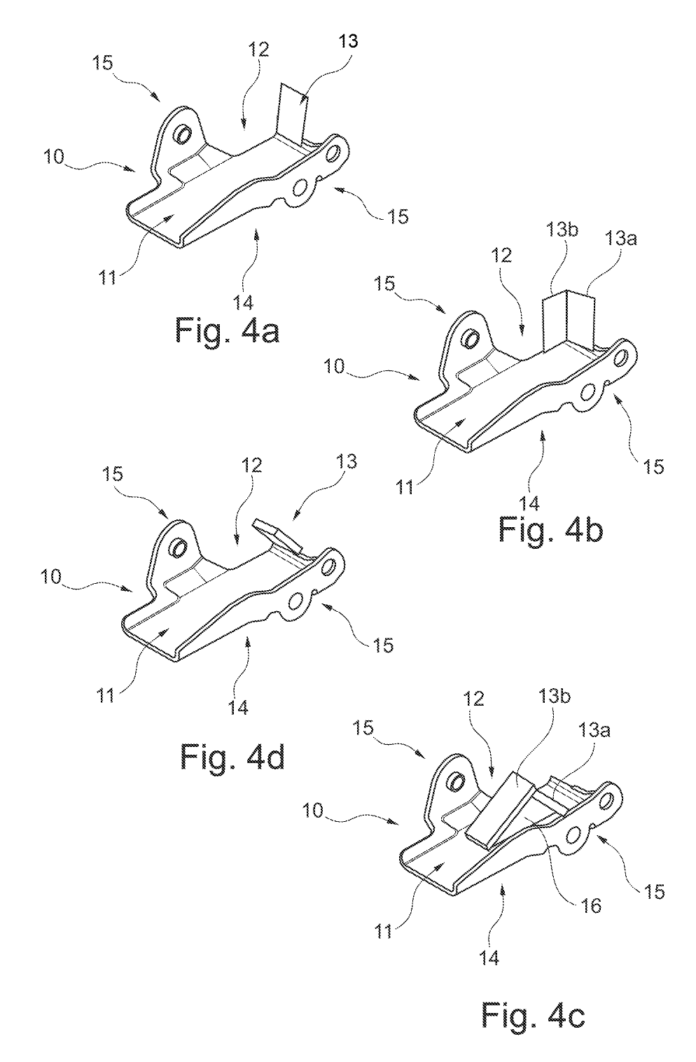

The dissipation or absorption of the kinetic energy takes place depending on the magnitude of the kinetic energy in two stages, in a first absorption stage by absorption and in a second absorption stage by redirecting. The proportion of the kinetic energy absorbed by deformation is dependent on the design of the absorption device 13, for example, on the stiffness or the height of the absorption device 13. Height is understood here as how far the absorption device 13 projects from the seat frame side 11 of the adapter apparatus 10. With regard to the various embodiments of the absorption device 13, reference is made to FIGS. 4a-f. The configuration of the absorption device 13 can be additionally adapted to a block size B of the vehicle seat 20 or dependent on this. Block size B is understood as a distance of the seat frame 21 to the seat rail 22 in a lowest position. By means of an adjustment of the block size B, a vehicle seat 20 can be individually adapted to a motor vehicle. The larger is the block size B, the higher and optionally the stiffer the absorption device 13 should be.

FIGS. 4a-d each show a perspective view of the adapter apparatus with various designs of the absorption device 13. The adapter apparatus 10 fundamentally corresponds to the design in FIG. 2. A detailed description of components already described is therefore dispensed with.

The absorption device 13 of FIG. 4a fundamentally corresponds to the one-part absorption device 13 of FIG. 2. According to FIG. 4a, however, the absorption device 13 is configured to be longer or higher and therefore adapted to a larger block size of, for example, about 185 mm±15 mm.

FIGS. 4b and c each show two-part absorption devices 13. The two-part absorption devices 13 each comprise two interconnected segments 13a and 13b. In FIG. 4b the segments 13a and 13b are arranged almost at right angles at an angle to one another, where both project from the seat frame side 11. The first segment 13a is fixed on a rear transverse edge of the adapter apparatus 10. The second segment 13b is fixed on a longitudinal edge of the adapter apparatus 10 adjoining the first segment 13a. As a result of this arrangement of the segments 13a and 13b, an absorption device 13 having a relatively high stiffness is achieved with good deformation behavior at the same time so that a high kinetic energy can be absorbed.

The same applies for the embodiment of FIG. 4c. Here the segments 13a and 13b are also each designed as flat, rectangular tongues, which project at an angle from the seat frame side 11 and thereby form a type of deformation bridge. In the event of a crash, the seat frame 21 presses onto the uppermost point of the absorption device 13 or the segments 13a and 13b and presses these flat in the direction of the seat frame side 11. In this embodiment the seat frame side 11 has a material recess 16 in the area below the segments 13a and 13b in order to save material when fabricating the adapter apparatus 10.

In FIG. 4d the absorption device 13 is formed in one piece. The absorption device 13 is configured as a tongue projecting at an angle from the front frame side 11. Here an angle of about 45° is provided between the absorption device 13 and the seat frame side 11 since this has shown good absorption results.

Overall the embodiments therefore describe an improved design of a seat adapter, also called belt adapter bracket, on a modular vehicle seat system. In a modular seat structure it is necessary for the block size to be variable in a certain range. In the seat structure described hereinbefore, this is achieved by using different adapter apparatuses, also called adapter brackets. The seat mount for the seat frame is set at different heights on the adapter brackets. Thus, in principle the same seat structure can be installed in different classes of vehicles. On account of a lowered roof line, a sports vehicle possibly requires a somewhat more compact seat structure than a mid-range vehicle in which seat comfort plays a greater role. The seat structure is in principle designed for different load cases; a special load case is the rear impact with 95% dummy weight. Here the seat kinematics are severely loaded. Deformation paths are included here as measured quantities. In a modular seat structure as specified above, there is the problem that the lowest position of the seat structure is at different heights above the seat rail depending on the block size. The seat frame is specially designed in the event of a 95% crash such that the seat frame is supported on the seat rail during deformation and thus guides the forces past the kinematics directly into the substructure. The embodiment produces such a bypass by forming in the rear belt bracket (left and right rail) respectively one energy absorption device in the form of a folded edge or crash tongue, which projects upward in the direction of the seat frame. This can then compensate for the particular increase in block size and therefore form a bypass in the load path. In one embodiment the crash tongue is designed as a deformation element in order to form not only a stiff stop but in order to simultaneously dissipate energy in the loaded case. In an optional design, a deformation region is provided in the seat frame, which then absorbs energy on contact with the crash tongue and closes the bypass. The crash tongue itself can either be formed directly from the bracket or mounted as an additional part on the bracket.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A seat adapter apparatus for fixing a seat frame to a moving part of a seat rail of a vehicle seat of a motor vehicle, the seat adapter apparatus comprising:
a seat frame side with a seat mount; and
an energy absorption device coupled to the seat frame side, the energy absorption device configured to absorb at least a portion of a kinetic energy of the vehicle seat and/or redirect it to the seat rail in an event of a crash of the motor vehicle.

2. The seat adapter apparatus according to claim 1, wherein the energy absorption device is deformable to absorb the at least the portion of the kinetic energy at least partially by deformation.

3. The seat adapter apparatus according to claim 1, wherein the energy absorption device is formed integrally with the seat frame side.

4. The seat adapter apparatus according to claim 1, wherein the energy absorption device is separate from the seat frame side and is connected to the seat frame side.

5. The seat adapter apparatus according to claim 1, wherein the energy absorption device is one piece.

6. The seat adapter apparatus according to claim 1, wherein the energy absorption device is in multiple parts with connected segments.

7. The seat adapter apparatus according to claim 1, wherein the energy absorption device comprises a metal.

8. The seat adapter apparatus according to claim 7, wherein the energy absorption device comprises aluminum and/or carbon.

9. A vehicle seat of a motor vehicle, the vehicle seat comprising:
a seat rail;
a seat frame; and
a seat adapter that couples an at least partially movable portion of the seat rail and the seat frame, wherein the seat adapter comprises:
a seat frame side with a seat mount;
an energy absorption device coupled to the seat frame side, the energy absorption device configured to absorb at least a portion of kinetic energy of the vehicle seat and/or redirect it to the seat rail in an event of a crash of the motor vehicle.

10. The vehicle seat according to claim 9, wherein the energy absorption device is deformable to absorb the at least the portion of the kinetic energy at least partially by deformation.

11. The vehicle seat according to claim 9, wherein the energy absorption device is formed integrally with the seat frame side.

12. The vehicle seat according to claim 9, wherein the energy absorption device is separate from the seat frame side and is connected to the seat frame side.

13. The vehicle seat according to claim 9, wherein the energy absorption device is a single piece.

14. The vehicle seat according to claim 9, wherein the energy absorption device is in multiple parts with connected segments.

15. The vehicle seat according to claim 9, wherein the energy absorption device comprises a metal.

16. The vehicle seat according to claim 15, wherein the energy absorption device comprises aluminum and/or carbon.

17. A motor vehicle having a vehicle seat comprising:
a seat rail;
a seat frame; and
a seat adapter that couples an at least partially movable portion of the seat rail and the seat frame, wherein the seat adapter comprises:
a seat frame side with a seat mount;
an energy absorption device connected to the seat frame side, the energy absorption device configured to absorb at least a portion of kinetic energy of the vehicle seat and/or redirect it to the seat rail in an event of a crash of the motor vehicle.

18. A method for absorbing a kinetic energy of a vehicle seat in an event of a crash, the vehicle seat comprising:
a seat rail;
a seat frame; and
a seat adapter that couples an at least partially movable portion of the seat rail and the seat frame, wherein the seat adapter comprises:
a seat frame side with a seat mount;
an energy absorption device connected to the seat frame side, the method comprising the steps of:
at least partially absorbing the kinetic energy using the seat adapter via the energy absorption device and/or redirecting the kinetic energy to the seat rail using the seat adapter via the energy absorption device.

19. The method according to claim 18, further comprising dissipating a first portion of the kinetic energy by deformation of the energy absorption device and passing a second portion of the kinetic energy to the seat rail via the seat adapter.
